(19) United States
(12) Patent Application Publication
(10) Pub. No.: US 2026/0352443 A1
(43) Pub. Date: Nov. 5, 2026

(54) MECHANISMS FOR ARTIFICIAL INTELLIGENCE MODEL PROTECTION AT EDGE DEVICES

(71) Applicant: Microsoft Technology Licensing, LLC, Redmond, WA (US)

(72) Inventors: Ling Tony CHEN, Bellevue, WA (US); Balaji BADAM, Cupertino, CA (US); Matthew D. MORRIS, Seattle, WA (US)

(21) Appl. No.: 19/197,630

(22) Filed: May 2, 2025

(51) Int. Cl. H04L 9/08; G06F 21/10; H04L 9/14

(52) U.S. Cl. CPC H04L 9/0819; G06F 21/105; H04L 9/14

(57) ABSTRACT

Technology is disclosed for securing models executed at edge devices. The edge devices include an SoC having a CPU, a memory and memory controller, a security processor (SP), and a specialized processing unit (SPU) (e.g., neural processing unit). The SP may attest to the identity of firmware of the SP and SPU to obtain a decryption key to decrypt the encrypted model downloaded to unprotected memory space. The memory controller may configure a protected memory space and encrypt data written to the protected memory space with an encryption key corresponding to the requestor. The SP may write the decrypted model to the protected memory space, and the memory controller may encrypt the model with a key corresponding to the SP that is available to the SPU. The SPU may retrieve and execute the model, while other modules, such as the CPU, may not access the protected memory space.

### TECHNICAL FIELD

Aspects of the disclosure are related to the field of computing software and hardware and, in particular, to securing artificial intelligence models executed on edge devices.

### BACKGROUND

Artificial intelligence is becoming increasingly common, and many expect it to transform humans'ability to interpret information far beyond currently existing capabilities. Artificial intelligence holds the possibility of revolutionizing the way humans interact with computers and the possibility of augmenting human intelligence by accelerating the way information is processed and interpreted in a meaningful way. These advancements require delivering solutions to perform complex tasks with efficiency that can only be achieved when certain artificial intelligence tasks are offloaded to edge devices. However, these complex tasks are performed by complex artificial intelligence and machine learning models that require substantial investment for development. These valuable models need to be protected because once released to edge devices, bad actors may access the data that makes the models valuable (e.g., weights and parameters designed to effectively solve complex tasks). Once the bad actors have hacked into the model to extract the valuable data, the value of the model is lost.

To protect valuable models, owners may restrict their usage to cloud servers. However, as discussed above, this restricts the efficiencies gained by executing these models at the edge. For example, a robot or self-driving car may still need to perform certain complex actions autonomously in offline mode when it is not possible to reach the cloud servers. While edge execution is needed in some cases, there is currently no way to protect models executed on untrusted edge platforms such as client personal computers. Once delivered to an untrusted edge platform, the model may be stolen. Accordingly, improvements are needed.

### OVERVIEW

Technology is disclosed herein for securing model (e.g., artificial intelligence models, machine learning models, and the like) execution on edge devices. To achieve a secure environment, memory controllers are flexibly programmed to create protected memory spaces accessible only to secure hardware modules (e.g., security processors, neural processing units, and the like) that can decrypt and execute the model without access by unsecure modules. To obtain the decryption key, a security processor can attest to the identity of firmware executed by the secure hardware modules. In response to the attestation, the cloud server providing the model can confirm the attestation, and in response, provide the decryption key to the security processor to decrypt the downloaded model. The encrypted model may be stored in unprotected memory after download. The security processor can use the decryption key to decrypt the model and store the decrypted model in a protected memory space accessible only to the secure hardware modules. The protected memory space is protected by the memory controller. The memory controller can be flexibly programmed to encrypt data stored in the protected memory space using a particular encryption key accessible only to the secure hardware modules or particular hardware modules. For example, the memory controller can be programmed to create a protected memory space that is encrypted and decrypted using a particular encryption key when accessed by the security processor and the neural processing unit. However, when other hardware modules attempt to access the protected memory space, the memory controller may either deny access or use a different encryption key. Accordingly, if an unallowed hardware module (e.g., the central processing unit) attempts to read the model from the protected memory space, the memory controller may either deny access or decrypt the model using a key associated with the unallowed hardware module, thereby providing unintelligible data. Meanwhile, the secure hardware modules can execute the model, using their attested to software, hardware, and/or firmware to protect the model during execution.

More technically, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer-implemented method for securing models (e.g., artificial intelligence (AI) models, machine learning models, and the like) executed at an edge computing device. The computer implemented method may include downloading, by the edge computing device, an encrypted model. A security processor of the edge computing device may attest to an identity of firmware of a plurality of hardware modules of the edge computing device. In response to the attestation, the security processor may receive a decryption key and decrypt the encrypted model using the decryption key. The security processor may store the decrypted model to a protected memory space, where data written to the protected memory space by the plurality of hardware modules is encrypted by a memory controller using an encryption key not available to other hardware modules not in the plurality of hardware modules. At least one of the plurality of hardware modules may retrieve and execute at least a portion of the model from the protected memory space. Other embodiments of this aspect include corresponding computer systems, apparatus, and computer programs recorded on one or more computer storage devices, each configured to perform the actions of the methods.

Implementations may include one or more of the following features. Optionally, the plurality of hardware modules may include the security processor and at least one neural processing unit or graphics processing unit. The other (i.e., unsecure) hardware modules may include a central processing unit.

Optionally, the central processing unit accesses the protected memory space via the memory controller, the memory controller decrypts the data using a second encryption key available to the central processing unit, and the data decrypted using the second encryption key is unintelligible by the central processing unit.

Optionally, the hardware modules retrieving and executing at least a portion of the model may include the neural processing unit, the graphics processing unit, or a combination thereof.

Optionally, the attesting to the identity of the firmware may include, for each of the plurality of hardware modules: loading the respective firmware onto a first hardware module of the plurality of hardware modules, measuring the respective firmware by the first hardware module, and providing the measurement of the respective firmware for the attesting.

Optionally, the plurality of hardware modules, the memory including the protected memory space, the memory controller, and at least one of the other hardware modules are all incorporated into a system on a chip (SoC).

Optionally, the programming the memory controller may include instructing the memory controller to: encrypt the data written to the protected memory space by any of the plurality of hardware modules with the encryption key, use the encryption key to decrypt the data when read from the protected memory space by any of the plurality of hardware modules, and use a different encryption key corresponding to the requesting hardware module to encrypt and decrypt the data when written to or read from the protected memory space by any other hardware module not in the plurality of hardware modules.

Optionally, the attesting to the identity of the firmware may include a freshness element indicating the identity of the firmware corresponding to each of the plurality of hardware modules is current.

Optionally, the encrypted model is downloaded to a second memory space, where the memory controller does not encrypt data written to the second memory space (e.g., the second memory space is unprotected).

Optionally, the executing the model may include: accessing a second memory space to read input data, processing the input data with the model, and writing output data from the model to a third memory space. In some embodiments, the memory controller encrypts data written to at least one of the second memory space with a second encryption key and the third memory space with a third encryption key when written by one of the plurality of hardware modules. Further, the second encryption key and the third encryption key are not available to the other hardware modules.

Optionally, the security processor may enforce license limitations. The license limitations may include at least one of a number of times the model may be executed, a number of concurrent executions of the model, and a duration of time during which the model may be executed. Implementations of the described techniques may include hardware, a method or process, or computer software or firmware on a computer-accessible medium.

Another general aspect includes a system on a chip (SoC). The SoC may include a central processing unit, a memory controller, one or more security processors, and a specialized processing unit. The memory controller may be configured to control access to a memory, configure a protected memory space of the memory, and encrypt data written to the protected memory space with an encryption key corresponding to a requestor. The one or more security processors may be configured to attest to an identity of firmware of a plurality of hardware modules, which may include a specialized processing unit and the one or more security processors. The one or more security processors may further be configured to receive, in response to the attesting, a decryption key, decrypt an encrypted model stored in the memory using the decryption key, and write the decrypted model to the protected memory space of the memory. The memory controller encrypts the model using the encryption key corresponding to the one or more security processors, the encryption key is not available to other hardware modules not in the plurality of hardware modules, and the central processing unit is one of the other hardware modules (i.e., the central processing unit cannot access the model in the protected memory space). The specialized processing unit may be configured to access the protected memory space via the memory controller and retrieve and execute at least a portion of the model from the protected memory space. Other embodiments of this aspect include corresponding computer systems, apparatus, and computer programs, including software and firmware, recorded on one or more computer storage devices, each configured to perform the actions of the methods.

Implementations may include one or more of the following features. Optionally, the specialized processing unit is a neural processing unit, a graphics processing unit, or both. In other words, the specialized processing unit may be two or more processing units.

Optionally, to attest to the identity of the firmware, the one or more security processors are further configured to for each of the plurality of hardware modules: load the respective firmware onto a first hardware module of the plurality of hardware modules, measure the respective firmware by the first hardware module, and provide the measurement of the respective firmware for the attestation. Optionally, to attest to the identity of the firmware, the one or more security processors are further configured to incorporate a freshness element indicating the identity of the firmware corresponding to each of the plurality of hardware modules is current.

Optionally, the one or more security processors are further configured to program the memory controller to configure the protected memory space. The programming may include instructing the memory controller to encrypt the data written to the protected memory space by any of the plurality of hardware modules with the encryption key, use the encryption key to decrypt the data when read from the protected memory space by any of the plurality of hardware modules, and use a different encryption key corresponding to a requesting hardware module to encrypt and decrypt the data when written to and read from the protected memory space by any other hardware module not in the plurality of hardware modules.

Optionally, the central processing unit is configured to download the encrypted model and write the encrypted model in a second memory space of the memory. The memory controller is further configured to configure the second memory space of the memory, where data written to the second memory space is not encrypted by the memory controller.

Optionally, the central processing unit is configured to read the model from the protected memory space via the memory controller, where the memory controller decrypts the model with a second encryption key corresponding to the central processing unit, and where the model decrypted with the second encryption key is unintelligible by the central processing unit.

Optionally, the one or more security processors are further configured to enforce license limitations on the model. The license limitations may include at least one of a number of times the model may be executed, a number of concurrent executions of the model, and a duration of time during which the model may be executed.

Optionally, the memory controller is further configured to configure a second protected memory space of the memory and encrypt data written to the second protected memory space with a second encryption key corresponding to a requestor. The specialized processing unit is further configured to access a third memory space to read input data, execute the at least the portion of the model to process the input data, and write output data from the model to the second protected memory space. The memory controller encrypts the output data written to the second protected memory space with the second encryption key corresponding to the specialized processing unit, and the second encryption key is not available to the other hardware modules. Implementations of the described techniques may include hardware, a method or process, or computer software on a computer-accessible medium.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an example environment for securing models executing on edge devices, according to various embodiments.

FIG. 2 illustrates additional details of an example system on a chip (SoC) for securing models executing on edge devices using firmware attestation, according to various embodiments.

FIG. 3 illustrates further details of the example SoC for securing models executing on edge devices using flexible programming of protected memory spaces, according to various embodiments.

FIG. 4 illustrates further details of the example SoC for securing models executing on edge devices using protected memory spaces, according to various embodiments.

FIG. 5 illustrates additional details of the example SoC for securing models executing on edge devices using protected memory spaces, according to various embodiments.

FIG. 6 illustrates an example method for securing models executing on edge devices, according to various embodiments.

FIG. 7 illustrates an example data flow for securing models executing on edge devices, according to various embodiments.

FIG. 8 illustrates additional details of the example SoC for securing input data, output data, or both from models executing on edge devices, according to various embodiments.

FIG. 9 illustrates a computing system suitable for implementing the various operational environments, architectures, processes, scenarios, and sequences discussed below with respect to the other Figures.

### DETAILED DESCRIPTION

Technology is disclosed herein that ensure secure execution of models (e.g., artificial intelligence models, machine learning models, and the like) on edge devices. Typically, once a model is downloaded and decrypted on an untrusted device, a bad actor may access and steal the value of the model (e.g., the weights and parameters specific to the training and development of the model) using the central processing unit. While this theft may be mitigated by executing models on secure cloud platforms, some advantages of edge processing are lost, and offline use of a model is unavailable. Edge devices are often untrusted because they do not include the proper hardware, firmware, and software desired to perform secure execution of models. Disclosed herein is technology for securing edge devices to ensure that edge execution of models need not expose the model to bad actors.

The models may be downloaded to an edge device encrypted to protect the model while not in the protected environment. The edge device may include a system on a chip (SoC) that includes a central processing unit (CPU), specialized processing unit (SPU), security processor, a memory, and a memory controller. The SPU may be, for example, a neural processing unit, a graphics processing unit, or a combination of such. The SPU may be used to execute the model on the edge device. However, to ensure the model is properly secured, the security processor may need to attest to the identity of firmware of the secure hardware modules (e.g., the SPU and the security processor). Other hardware modules may be used and be secure hardware modules including more than one SPU, more than one security processor, and the like. The security processor may load the firmware for the secure hardware modules and take a measurement (e.g., a hash) of the firmware at boot or runtime. The security processor may provide the measurements for the secure hardware modules to the cloud server that provides access or licensing to the model. The cloud server may compare the attestation measurements to known good values, and if they match, provide a decryption key for the model to the security processor.

Once the security processor has the decryption key, the security processor may obtain the encrypted model from the memory, decrypt it with the decryption key, and write it to a protected memory space of the memory. The protected memory space may be configured by the memory controller such that for secure hardware modules that read from or write to the protected memory space, a particular encryption key is used to encrypt and decrypt the data. Accordingly, when the security processor writes the decrypted model to the protected memory space, the memory controller encrypts the model with an encryption key only accessible to the secure hardware modules of the SoC. Therefore, the SPU may access the model in the protected memory space and execute the model securely on the edge device. For example, the SPU firmware may ensure that while executing the model, the model data is not accessible by other hardware modules of the edge device. For example, the CPU may not access the protected memory space or the SPU registers, ensuring that unsecure hardware modules do not have access to the model.

Advantageously, the technology allows for secure edge computing. Distributing computing to edge processing allows for lower bandwidth usage between cloud servers and edge devices. Ensuring the secure execution of models on edge devices results in faster processing at the edge and availability even while offline of even the most valuable models. Flexible programming of the memory controller to enforce protected memory spaces maintains memory usage most robustly and efficiently. When larger protected memory spaces are needed, they can be flexibly programmed, however, they can be released to unprotected memory spaces when not needed for security. Accordingly, the disclosed technology maintains efficient, flexible, and secure memory spaces for secure execution at the edge, which promotes bandwidth reduction over the network as well as faster processing and offline processing capabilities not otherwise available.

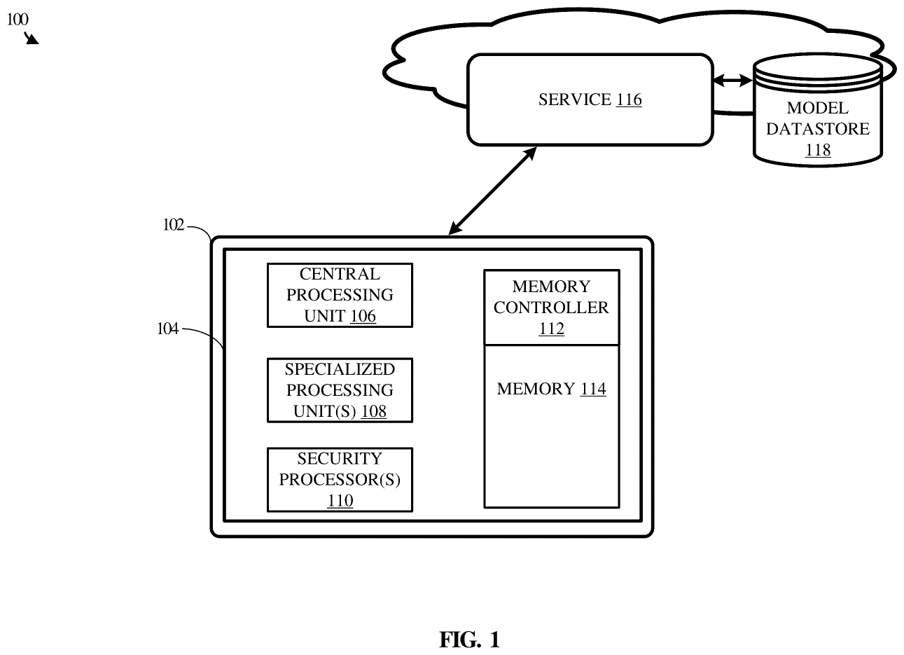

Turning now to the figures, FIG. 1 illustrates an example environment 100 for securely executing models at edge devices. Environment 100 includes edge device 102, service 116, and model datastore 118.

Service 116 represents any cloud-based, online, or server-based service through which edge device 102 can download a model for execution and from which edge device 102 may obtain a decryption key corresponding to a license for executing the model. Service 116 may be implemented in a cloud-based arrangement from, for example, a datacenter or using a server accessible over a network (e.g., the Internet, a wide area network, or any such network configuration). One or more computing systems (e.g., computing device 901) may include instructions that are executed by a processor to provide the functionality of service 116. While one service 116 is depicted for ease of description, any number of services 116 may be included in environment 100. Service 116 may make models stored in model datastore 118 available to edge device 102 for download. Model datastore 118 may include any models or data which may be secured using the technology discussed herein. Model datastore 118 may be hosted on a server or a cloud-based system and be accessible by service 116. While one model datastore 118 is depicted for ease of description, any number of model datastores 118 may be included in environment 100. Models in model datastore 118 may include any artificial intelligence model, machine learning model, or the like. Model datastore 118 may include any number of models, and each model may be protected independently using the same technology described herein whether executed on one edge device 102 or separate edge devices 102. Models in model datastore 118 represent models that may be executed on edge device 102 and which the owners of the models may wish to secure execution on edge device 102 to ensure the value of the model is not stolen. Accordingly, models in model datastore 118 may be encrypted such that to access the model, it must be decrypted using a decryption key. However, to ensure the models are not decrypted and the value stolen, service 116 may provide the decryption key only to edge device 102 after it performs particular actions described further herein. Edge device 102 may access service 116 via a graphical user interface, via an application programming interface (API), or the like.

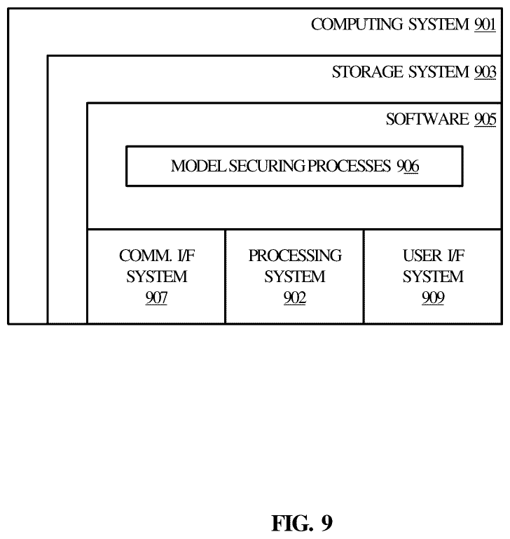

Edge device 102 may be any computing device having the particular components and functionality described herein. For example, edge device 102 may be a personal computer, laptop, gaming device, tablet, smartphone, autonomous vehicle, or the like. While a single edge device 102 is depicted for ease of description, any number of edge devices 102 may be included in environment 100. Edge device 102 includes system on a chip (SoC) 104. Details of computing device 901 are described and depicted with respect to FIG. 9. Edge device 102 may be an implementation of computing device 901 such that edge device 102 may include other hardware and software not described with respect to edge device 102 without departing from the scope of the disclosure. For example, edge device 102 may include communication interfaces (e.g., communication interface system 907), user interfaces (e.g., user interface system 909), and the like.

SoC 104 includes central processing unit (CPU) 106, specialized processing unit (SPU) 108, security processor 110, memory controller 112, and memory 114. While the components on SoC 104 may be implemented in edge device 102 without being implemented in SoC 104, implementation as an SoC provides additional security benefits. For example, a bad actor will find that intercepting messages between the components (e.g., between security processor 110 and memory controller 112) is more difficult due to sizing and physical structure on an SoC than if the components were not implemented in an SoC. Accordingly, implementation as an SoC provides even greater security at edge device 102. SoC 104 may include other components not described herein for the sake of brevity.

CPU 106 may be a primary component of edge device 102 responsible for executing instructions that, for example, implement the operating system on edge device 102. CPU 106 is typically used for general processing on edge device 102, and therefore may not be a secure hardware module. For example, bad actors may leverage CPU 106 to perform actions that are undesirable with respect to execution of models on edge device 102. Because CPU 106 is needed to perform general tasks on edge device 102, securing CPU 106 is impossible or undesirable to avoid constraining CPU 106 from performing needed tasks. CPU 106 may include any number of

SPU 108 may include one or more specialized processing units such as one or more neural processing units, one or more graphics processing units, or a combination of one or more of each. A neural processing unit (NPU) is a specialized and dedicated hardware accelerator that handles the heavy mathematical computations often needed for executing models. NPUs are designed to accelerate artificial intelligence (AI) and machine learning (ML) tasks. NPUs generally include processing cores, memory (e.g., registers, cache, or other small NPU specific memory), and firmware, among other hardware and software. The firmware of the NPU performs initial setup and booting, instruction scheduling, memory management to coordinate data movement between NPU memory and memory 114, power and performance optimization, security an integrity to ensure only authenticated or verified models and code run on the NPU hardware, ensure other hardware modules cannot access NPU cache and registers, and so forth. A graphics processing unit (GPU) is a specialized processor designed to render graphics and images efficiently, and GPUs have evolved into powerful parallel processors used in gaming, three-dimensional (3D) rendering, video editing, and so forth. GPUs are optimized to handle large blocks of data and perform many operations simultaneously. GPUs generally include processing cores, memory (e.g., registers, cache video random access memory (VRAM)), and firmware, among other hardware and software. The firmware of the GPU is responsible for hardware initialization, power and thermal management, security and integrity to ensure other hardware modules cannot access the GPU memory, and so forth. On edge device 102, SPU 108 executes at least a portion of the model.

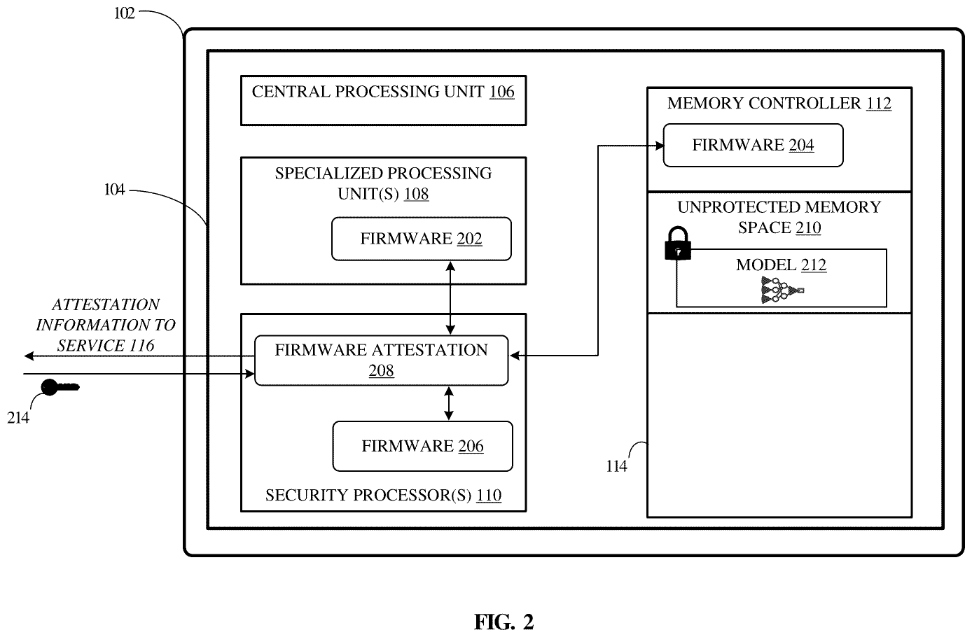

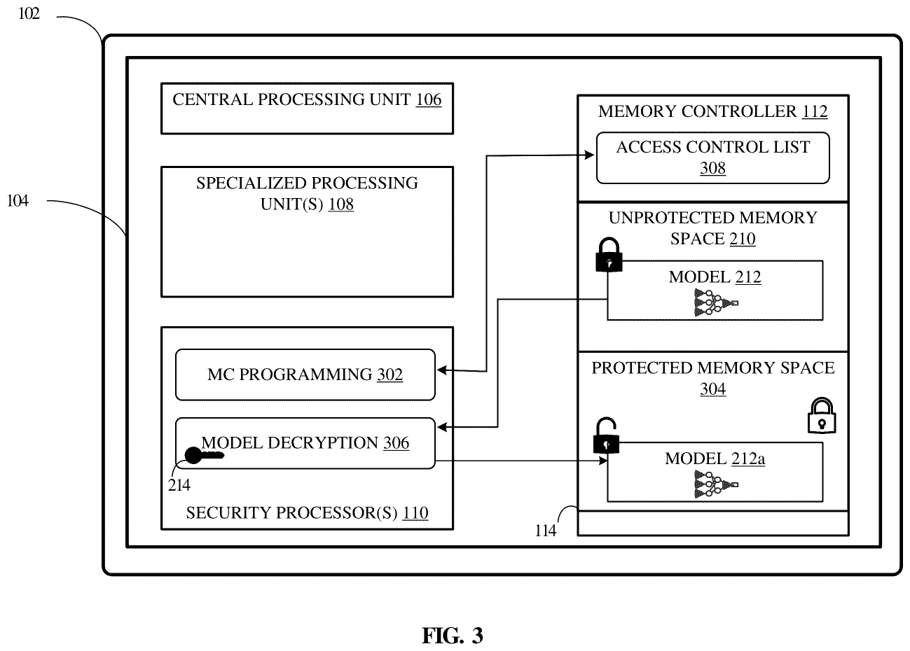

Security processor 110 is a trusted hardware module used to handle security of models on edge device 102. Security processor 110 may be one or more microprocessors that perform the security functions described herein. For example, security processor 110 may attest to the firmware of security processors 110 and specialized processing units 108 as described with respect to FIG. 2. The attestation may be provided to service 116 to obtain the decryption key for decrypting the model. Further, security processor 110 may flexibly program memory controller 112 to configure protected memory spaces within memory 114 to ensure the model can be decrypted and accessed securely by SPU 108, as described with respect to FIG. 3-5. Additionally, security processor 110 may enforce licensing requirements of models from service 116 including limiting the number of times a model may be executed, the number of currently running model executions allowed for a model (e.g., the model may only have three concurrent executions), the length of time the model may be used (e.g., the license expires one week from initial access), and so forth.

Memory controller 112 controls access to memory 114. Memory 114 may be system memory for edge device 102. Memory 114 may be, for example, random access memory (RAM) including dynamic RAM (DRAM), static RAM (SRAM), magnetoresistive RAM (MRAM), Flash, Persistent memory, or any combination thereof. Memory 114 may be used to store program instructions, operating system data, application data actively being used, and the like. Memory controller 112 may be a digital logic circuit that manages the flow of data between memory 114 and the other components in edge device 102 including CPU 106, SPU 108, and security processor 110. For example, memory controller 112 performs address translation, performs memory commands, coordinates and enforces timing rules, performs error handling, and handles power management. Further, memory controller 112 may be flexibly programmed by security processor 110 to configure and enforce protected memory spaces in memory 114. Protected memory spaces are described in more detail with respect to FIG. 3-5.

FIG. 2 illustrates additional details of edge device 102 and the initial portion of the process to obtain model 212 from service 116. Edge device 102 may download model 212 from service 116 via a graphical user interface or application programming interface (API). In some embodiments, CPU 106 or security processor 110 may download model 212 and store model 212 in unprotected memory space 210. Model 212 may be encrypted when downloaded to protect model 212 from unauthorized access. Service 116 may encrypt model 212 prior to making it available for download. Unprotected memory space 210 may be a memory space within memory 114 that memory controller 112 controls access to but does not place restrictive controls on. In other words, CPU 106, SPU 108, and security processor 110 may all access unprotected memory space 210 via memory controller 112.

To obtain decryption key 214 needed to decrypt model 212, security processor 110 may attest to the identity of firmware of the secure hardware modules of edge device 102. The secure hardware modules include any hardware modules which may access model 212. Accordingly, SPU 108, security processor 110, and memory controller 112 may each be considered secure hardware modules. When multiple SPUs 108 or security processors 110 are included, those that are secure must be attested to. In other words, more than one SPU 108 and/or more than one security processor 110 may include firmware which is attested to by security processor 110 using firmware attestation 208. Further, SoC 104 may include one or more neural processing units (NPUs), graphics processing units (GPUs), or other any processing units or hardware modules that are not intended to access model 212. Those processing units and hardware modules not intended to access model 212 as well as CPU 106 are not secure hardware modules and therefore security processor 110 need not attest to the identity of the firmware of those components (i.e., unsecure hardware modules). As one example, a single SPU 108, a single security processor 110, and memory controller 112 are the secure hardware modules in the example depicted in FIG. 2. SPU 108 may include firmware 202, security processor 110 may include firmware 206, and memory controller 112 may include firmware 204. In some embodiments, memory controller 112 may not include firmware and therefore may not be included in the attestation. Security processor 110 may execute firmware attestation 208. Firmware attestation 208 may be, for example, instructions executed by security processor 110 for performing attestation. Firmware attestation 208 may include instructions for a process that security processor 110 executes to load firmware (e.g., firmware 202, firmware 206, firmware 204) and take a measurement of each firmware. For example, security processor 110 may load each firmware and calculate a hash representing the identity of the particular firmware. Security processor 110 provides the measurements to service 116 for attestation. In some embodiments, the attestation information includes the measurements as well as a freshness element indicating that the measurements were collected within a specified time frame. The freshness element may help ensure that a bad actor may not use measurements from a prior firmware version of a secure hardware module In some embodiments, a second security processor (not shown) may load the firmware, take the measurements, and provide the measurements to security processor 110. In other words, various functionalities described with respect to security processor 110 may be divided into one or more security processors.

Service 116 may receive the attestation information from security processor 110 and confirm the identity of the firmware of the secure hardware modules on SoC 104 match the expected values. For example, the measurement (e.g., hash) of each firmware may be compared to the expected measurement for the firmware for each secure hardware module. To accept the attestation, service 116 determines that the firmware of each secure hardware module is correct (e.g., the correct version) and not tampered with. If service 116 accepts the attestation provided by security processor 110, service 116 provides the decryption key 214 for decrypting model 212. In addition to decryption key 214, service 116 may provide license requirements for accessing model 212. Security processor 110 may enforce the license requirements imposed by service 116. The license requirements may include any limitation on model 212 imposed by service 116. For example, the license may limit the number of executions of model 212 that edge device 102 may perform, the number of concurrent executions of model 212, or the length of time model 212 may be stored and used on edge device 102.

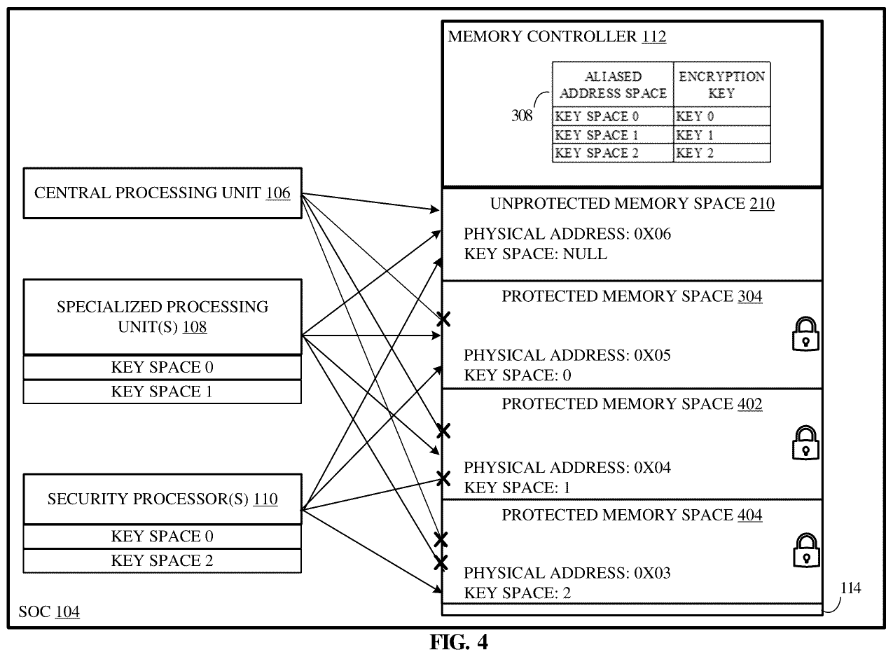

FIG. 3 illustrates additional functionality security processor 110 and memory controller 112 use to secure model 212 on edge device 102. Upon download and storage in unprotected memory space 210, model 212 is encrypted. After the attestation process described with respect to FIG. 2, security processor 110 has decryption key 214. Security processor 110 is further responsible for flexibly programming memory controller 112 to configure protected memory space 304. Security processor 110 has attested to the secure hardware modules SPU 108 and security processor 110, accordingly, security processor 110 may program memory controller 112 to configure protected memory space 304 to allow only the secure hardware modules (e.g., security processor 110 and SPU 108) to access data within protected memory space 304. Security processor 110 may program memory controller 112 using memory controller programming 302. Memory controller programming 302 may be, for example, instructions executed by security processor 110 that provide programming instructions or information to memory controller 112 for configuring protected memory spaces (e.g., protected memory space 304). As one example, memory controller 112 may use access control list 308 to allow or deny access by particular hardware modules to protected memory space 304. For example, access control list 308 may be used to allow SPU 108 and security processor 110 access to protected memory space 304 using a particular encryption key, but when other hardware modules (e.g., CPU 106) attempt to access protected memory space 304, a different encryption key associated with the requesting hardware module may be used, rendering the returned data unintelligible. In other embodiments, memory controller 112 may deny access by hardware modules other than those allowed by access control list 308 to access protected memory space 304. When configuring protected memory space 304, memory controller 112 may put entries in access control list 308 for which encryption key to use to encrypt and decrypt data written to and read from protected memory space 304 based on the requesting hardware module. This is described in more detail with respect to FIG. 4. Security processor 110 may use memory controller programming 302 to allow any secure hardware module access to the protected memory space (e.g., protected memory space 304) intended to store the decrypted model 212a. Secure hardware modules should include only those hardware modules to which security processor 110 attested to the identity of their firmware using firmware attestation 208. For example, if SPU 108 is implemented as a neural processing unit and a graphic processing unit, each of which may be used to execute at least a portion of model 212, both should be attested to, and both should be included in access to protected memory space 304, which is configured by memory controller programming 302. Note that security processor 110 may include some or all secure hardware modules (i.e., hardware modules that are attested to) in the access control list 308 for accessing protected memory space 304, but security processor 110 may not include any unsecure hardware modules (i.e., hardware modules that are not attested to) in access control list 308 for accessing protected memory space 304.

Security processor 110 may use model decryption 306 and decryption key 214 to decrypt model 212. Model decryption 306 may be, for example, instructions executed by security processor 110 to read model 212 from unprotected memory space 210, decrypt model 212 to generate decrypted model 212a, and write decrypted model 212a to protected memory space 304 via memory controller 112. When writing decrypted model 212a to protected memory space 304, memory controller 112 encrypts the data with an encryption key associated with security processor 110 as defined in access control list 308. Accordingly, model 212a is decrypted with respect to decryption key 214, but it is encrypted by the secure hardware modules of SoC 104 to ensure unsecure hardware modules (e.g., CPU 106) may not access model 212. While security processor 110 has model 212 in memory and performs decryption, firmware 206 and other security features of security processor 110 restrict other hardware modules (e.g., CPU 106) from accessing model 212 while security processor 110 is performing operations on model 212 in security processor 110 memory, caches, or registers. In some embodiments, security processor 110 deletes model 212 from unprotected memory space 210 upon decrypting and writing decrypted model 212a to protected memory space 304.

FIG. 4 illustrates an example of various protected and unprotected memory spaces that may be configured in memory 114 by memory controller 112. At least some of these protected memory spaces may be configured by memory controller 112 in response to security processor 110 executing memory controller programming 302. Memory 114 may include additional memory addresses beyond these example memory spaces. For example, memory 114 may include additional unprotected memory space not depicted for brevity. Access control list 308 shows example information including aliased address spaces and corresponding encryption keys used for the address spaces. In the example shown, key space 0 corresponds to encryption key 0, key space 1 corresponds to encryption key 1, and key space 2 corresponds to encryption key 2. Unprotected memory space 210 has a null key space. Since the key space is null, there is no encryption key, and memory controller 112 does not encrypt or decrypt data written to or read from unprotected memory space 210. Accordingly, CPU 106, SPU 108, and security processor 110 may all access unprotected memory space 210.

Protected memory space 304 is aliased to key space 0. Key space 0 corresponds to encryption key 0. SPU 108 and security processor 110 each have access to key space 0. Accordingly, when SPU 108 or security processor 110 write data to protected memory space 304, memory controller 112 encrypts the data with encryption key 0, and when SPU 108 or security processor 110 read from protected memory space 304, memory controller 112 decrypts the data with encryption key 0. However, when an unsecure hardware module such as CPU 106 that does not have access to key space 0 and therefore does not have access to protected memory space 304 attempts to read from or write to protected memory space 304, memory controller 112 may deny access based on access control list 308. In some embodiments, memory controller 112 may simply deny access or return no data. In other embodiments, memory controller 112 may use an encryption key corresponding to the requesting hardware module. For example, CPU 106 may have a default encryption key (e.g., encryption key X, not shown) that is used to encrypt and decrypt data written to and read from protected memory space 304. Accordingly, when memory controller 112 uses encryption key X to decrypt data encrypted with encryption key 0, unintelligible data is returned to CPU 106. Additionally, if CPU 106 attempts to write data to protected memory space 304, memory controller 112 may encrypt the data with encryption key X. This may corrupt data already stored in protected memory space 304 or, if later SPU 108 or security processor 110 attempt to read that data, memory controller 112 may decrypt the data with encryption key 0, which will also result in unintelligible data for SPU 108 or security processor 110.

Protected memory space 402 is aliased to key space 1. Key space 1 corresponds to encryption key 1. SPU 108 has access to key space 1. Accordingly, when SPU 108 writes data to protected memory space 402, memory controller 112 encrypts the data with encryption key 1, and when SPU 108 reads from protected memory space 402, memory controller 112 decrypts the data with encryption key 1. However, when other hardware modules such as CPU 106 and security processor 110 that do not have access to key space 1 and therefore do not have access to protected memory space 402 attempt to read from or write to protected memory space 402, memory controller 112 may deny access based on access control list 308. As described with respect to protected memory space 304, when unauthorized hardware modules attempt to access protected memory space 402, memory controller 112 may deny access or use a different encryption key corresponding to the requesting hardware module, resulting in unintelligible data.

Protected memory space 404 is aliased to key space 2. Key space 2 corresponds to encryption key 2. Security processor 110 has access to key space 2. Accordingly, when Security processor 110 writes data to protected memory space 404, memory controller 112 encrypts the data with encryption key 2, and when Security processor 110 reads from protected memory space 404, memory controller 112 decrypts the data with encryption key 2. However, when other hardware modules such as CPU 106 and SPU 108 that do not have access to key space 2 and therefore do not have access to protected memory space 404 attempt to read from or write to protected memory space 404, memory controller 112 may deny access based on access control list 308. As described with respect to protected memory space 304, when unauthorized hardware modules attempt to access protected memory space 404, memory controller 112 may deny access or use a different encryption key corresponding to the requesting hardware module, resulting in unintelligible data.

Note that while protected memory spaces 304, 402, and 404 may become corrupted when written to by an unauthorized hardware module or may return unintelligible data when read by an unauthorized hardware module, this is not typical behavior for the hardware modules. In other words, CPU 106 will not typically attempt to access protected memory space 304, 402, or 404. Rather, it is when a bad actor modifies typical behavior of a hardware module that an unauthorized attempt to read or write to a protected memory space may occur.

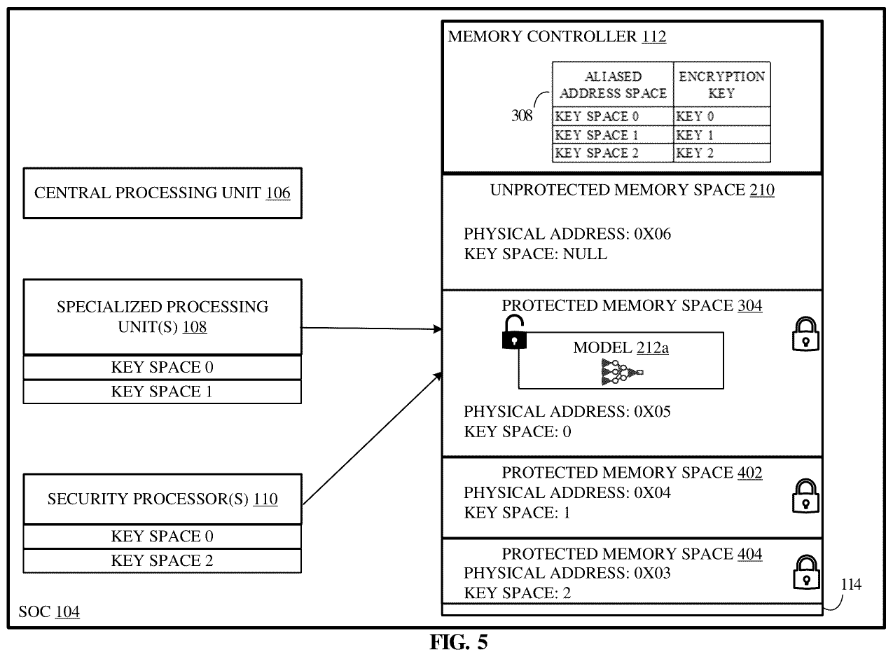

FIG. 5 illustrates memory 114 having several configured memory spaces as shown in FIG. 4 including unprotected memory space 210, protected memory space 304, protected memory space 402, and protected memory space 404. As described with respect to FIG. 3, security processor 110 decrypts model 212 obtained from unprotected memory space 210 and writes the decrypted model 212a to protected memory space 304. Protected memory space 304 is accessible as aliased address space key space 0 to SPU 108 and security processor 110 such that data written to protected memory space 304 by SPU or security processor 110 is encrypted by memory controller 112. Note that model 212a is itself decrypted such that when SPU 108 or security processor 110 read model 212a from protected memory space 304, model 212a is decrypted. However, all data written to protected memory space 304 is encrypted by memory controller 112 with an encryption key associated with the requestor. In the case of SPU 108 and security processor 110, which both have access to key space 0, encryption key 0 is used by memory controller 112 to encrypt data written to protected memory space 304 and decrypt data read from protected memory space 304. Accordingly, when SPU 108 or security processor 110 read model 212a from protected memory space 304, they receive a decrypted model 212a. However, if an unauthorized hardware module that does not have access to key space 0 attempts to read model 212a from protected memory space 304, memory controller 112 may deny access or may use a decryption key associated with the unauthorized hardware module. For example, CPU 106 does not have access to key space 0. If CPU 106 attempts to read model 212 a from protected memory space 304, memory controller 112 may deny access or may use a default encryption key (e.g., encryption key 3) associated with CPU 106 to decrypt the data. Since model 212a was written to protected memory space 304 by security processor 110, memory controller 112 used encryption key 0 to encrypt the data prior to writing it to protected memory space 304. When memory controller 112 decrypts the data using encryption key 3 and provides it to CPU 106, the returned data will be unintelligible. Accordingly, while model 212a itself is decrypted, the hardware enforced encryption implemented by memory controller 112 on protected memory space 304 protects decrypted model 212a from being read by unauthorized hardware modules. Further, SPU 108 has access to decrypted model 212a via memory controller 112 from protected memory space 304 and may execute model 212a. Security processor 110 may enforce license restrictions based on access to protected memory space 304 via memory controller 112. For example, security processor 110 may delete model 212a when the duration of the license expires. As another example, security processor 110 may delete model 212a when a number of executions of model 212a reaches a license limitation.

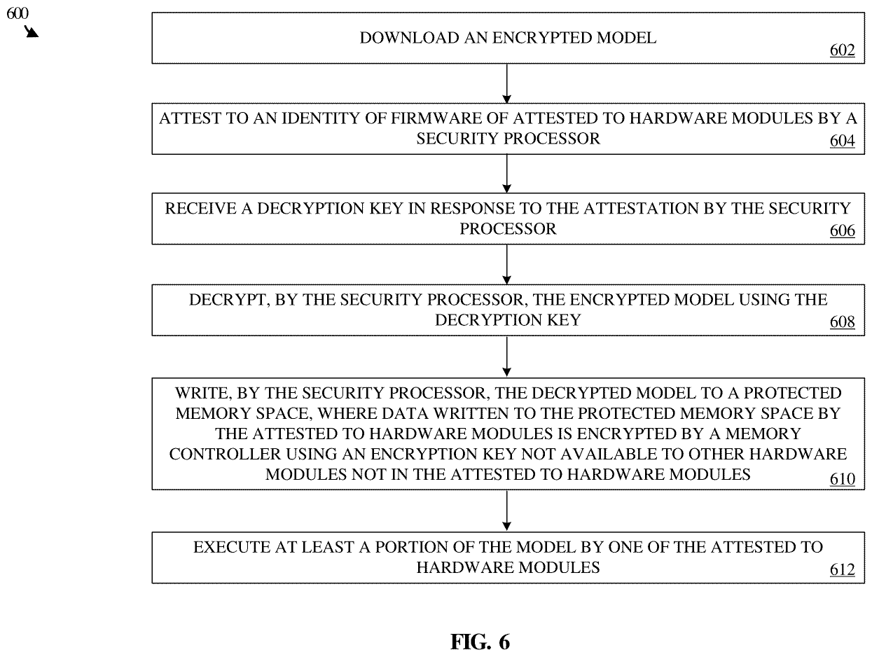

FIG. 6 illustrates an example method 600 for securing a model executing on an edge device. For example, method 600 may be performed by edge device 102 to secure model 212. Method 600 begins at step 602 with the edge device downloading an encrypted model. For example, edge device 102 may download model 212, which is encrypted, from service 116. Service 116 may provide model 212 from model datastore 118. Edge device 102 may download model 212 using a graphical user interface, an application programming interface, or any other suitable technology for accessing service 116 and downloading model 212. For example, CPU 106 or security processor 110 may execute instructions to download model 212 and store model 212 in unprotected memory space 210.

At step 604, a security processor attests to the identity of firmware of attested to hardware modules. For example, security processor 110 may execute firmware attestation 208 to attest to the identity of firmware 202 of SPU 108 and firmware 206 of security processor 110 using firmware attestation 208. In cases where memory controller 112 includes firmware 204, security processor 110 may further attest to the identity of firmware 204. While only some example hardware modules are depicted in the figures, security processor 110 may attest to the firmware of any hardware module (e.g., multiple SPUs 108 including neural processing units, graphics processing units, and the like; multiple security processors 110; or any combination) that is to be considered a secure hardware module for the purposes of accessing model 212. Accordingly, any SPU 108 that will have access to execute portions of model 212 should be included in the secure hardware modules that are attested to. In other words, any hardware module that will have access to protected memory space 304 should be included in the secure hardware modules that are attested to. To provide attestation information, security processor 110 may load the firmware of any secure hardware modules (e.g., firmware 202, firmware 204, firmware 206) and take a measurement (e.g., a hash) of the firmware. The attestation information may include the firmware measurements as well as a freshness element indicating that the firmware measurements are current. Security processor 110 may transmit the attestation information to service 116 for attestation.

At step 606, the security processor receives a decryption key in response to the attestation. For example, security processor 110 may receive decryption key 214 from service 116 if service 116 accepts the attestation. For example, service 116 may compare the firmware measurements (e.g., hash values) to expected measurements (e.g., expected hash values), and upon determining each measurement matches the expected measurement for the given hardware module, service 116 may provide decryption key 214 to security processor 110.

At step 608, the security processor may decrypt the encrypted model using the decryption key. For example, security processor 110 may execute model decryption 306 to read model 212 from unprotected memory space 210 and decrypt model 212 with decryption key 214. Because firmware 206 is attested to, the owner of model 212 trusts security processor 110 to protect decrypted model 212a while it is being decrypted and stored in security processor 110 registers, cache, or other locations protected by firmware 206 and security processor 110.

At step 610, the security processor writes the decrypted model to a protected memory space, where data written to the protected memory space by the attested to hardware modules is encrypted by a memory controller using an encryption key not available to other hardware modules not in the attested to hardware modules. For example, security processor 110 writes decrypted model 212a to protected memory space 304 via memory controller 112. Memory controller 112 uses access control list 308 to determine encryption key 0 should be used to encrypt and decrypt data written into and read from protected memory space 304 by security processor 110. However, memory controller 112 also uses access control list 308 to determine that CPU 106 may not use encryption key 0 to read from or write to protected memory space 304 since it does not have access to key space 0 and therefore does not have access to encryption key 0. Accordingly, when CPU 106 attempts to read model 212a from protected memory space 304, memory controller 112 may deny access or may use a different encryption key (e.g., encryption key 3) corresponding to CPU 106 to decrypt the data. Accordingly, CPU 106 receives unintelligible data when it reads from protected memory space 304. While CPU 106 does not have access to encryption key 0, SPU 108, which was attested to, does have access to key space 0 and encryption key 0. Accordingly, when SPU 108 reads model 212a from protected memory space 304, memory controller 112 decrypts the data with encryption key 0 and SPU 108 receives decrypted model 212a. In some embodiments, security processor 110 programs memory controller 112 to configure protected memory space 304 (e.g., using memory controller programming 302) to allow secure hardware modules (e.g., SPU 108 and security processor 110) access to protected memory space 304 corresponding to key space 0 and access to encryption key 0 and not allow any other hardware modules (e.g., CPU 106) access to protected memory space 304 or access to encryption key 0.

At step 612, at least one of the attested to hardware modules execute at least a portion of the model. For example, SPU 108 may execute at least a portion of model 212a by reading model 212a from protected memory space 304 via memory controller 112. Accordingly, memory controller 112 decrypts the data with encryption key 0 since SPU 108 has access to key space 0 and encryption key 0 before providing the data to SPU 108. Therefore, SPU 108 receives decrypted model 212a and can execute it. Since SPU 108 is attested to, service 116 trusts that SPU 108 will not allow other hardware modules (e.g., CPU 106) access to model 212a during execution or while it is in SPU 108 caches or registers, for example.

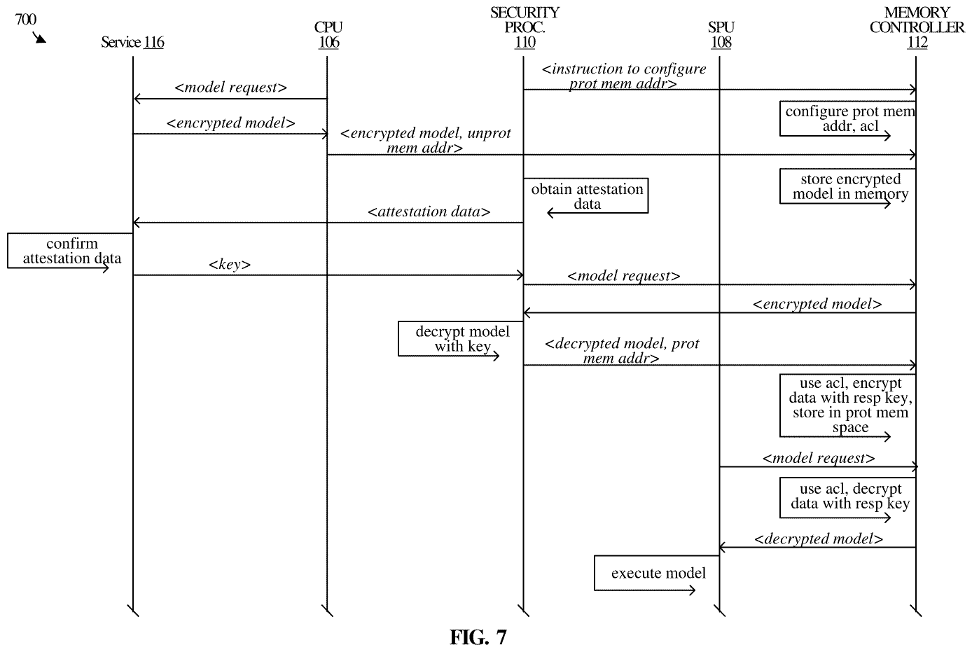

FIG. 7 illustrates an example operational scenario 700 for securely executing a model at an edge device using environment 100. CPU 106 may request a model from service 116 and receive an encrypted model (e.g., model 212) in response. CPU 106 writes the encrypted model to unprotected memory space (e.g., unprotected memory space 210), and memory controller 112 stores encrypted model 212 in unprotected memory space 210.

Security processor 110 may instruct memory controller 112 to configure a protected memory space (e.g., protected memory space 304), and memory controller 112 may configure protected memory space 304 and use access control list 308 to control access. While shown as an initial portion of the process, security processor 110 may flexibly program memory controller 112 to configure or reconfigure protected memory spaces at any time.

Security processor 110 may obtain attestation data including measurements of firmware of all secure hardware modules (e.g., security processor 110, SPU 108, and any other hardware modules not shown that are intended to access model 212). To obtain the measurements, security processor 110 may load the firmware and take the measurement. In some embodiments, a different security processor may load the firmware and take the measurements and provide the measurements to security processor 110. Security processor 110 sends the attestation data (e.g., firmware measurements and, in some cases, a freshness element) to service 116. Service 116 confirms the attestation data and returns the decryption key (e.g., decryption key 214). If service 116 does not accept the attestation (e.g., the firmware measurements do not match the expected values), service 116 will not send the decryption key 214 to security processor 110.

Once security processor 110 receives the decryption key 214, security processor 110 reads the model from the unprotected memory space via memory controller 112. Memory controller 112 sends encrypted model 212 from unprotected memory space 210 to security processor 110. Security processor 110 decrypts model 212 with decryption key 214 and writes decrypted model 212a to protected memory space 304 via memory controller 112. Memory controller uses access control list 308 to determine security processor 110 has access to protected memory space 304 and encrypts the data with encryption key 0.

SPU 108, also having access to encryption key 0 requests the model (i.e., reads the model) from memory controller 112 from protected memory space 304. Memory controller 112 uses access control list 308 to determine SPU 108 has access to encryption key 0, decrypts the data with encryption key 0, and returns the data to SPU 108. SPU 108 receives decrypted model 212a and executes at least a portion of model 212a.

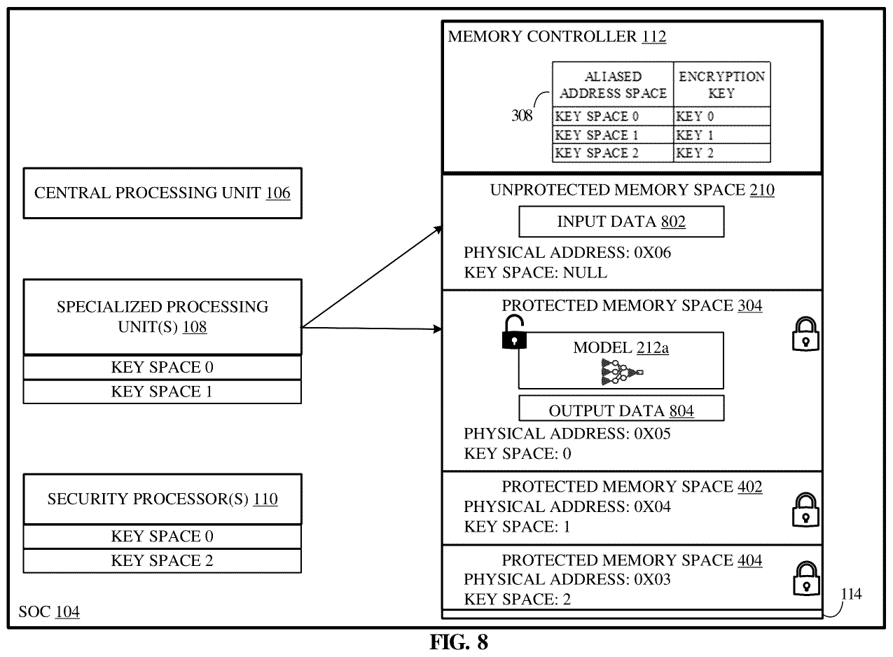

FIG. 8 illustrates an example of input data used for the model and output data from the model. Input data 802 may be obtained from unprotected memory space 210 as shown in FIG. 8. For example, the input data may not need to be secured. As one example, input data 802 may include sensor data obtained from sensors (not shown) on edge device 102, and CPU 106 may write input data 802 to unprotected memory space 210. If input data 802 should be secured, input data 802 may be stored in a protected memory space accessible by specialized processing unit 108 such as protected memory space 304 or protected memory space 402. Regardless of where input data 802 is stored, the hardware module executing model 212a needs access, so in the example shown, SPU 108 needs access to the memory space in which input data 802 is stored.

In the example of FIG. 8, output data 804 is secured because it is written to protected memory space 304, which is not accessible by unsecure (i.e., unattested to) hardware modules. In some examples, output data 804 need not be secured (e.g., it may be displayed on a graphical user interface) and can be stored in any unprotected memory space (e.g., unprotected memory space 210). Regardless of where output data 804 is stored, the hardware module executing model 212a needs access to write output data 804. Note that while the description herein has discussed memory access as read and write access, in some embodiments, particular hardware modules may have limited access to protected memory spaces. For example, in some embodiments, SPU 108 may have only read access to protected memory space 304 and may not have access to write data to protected memory space 304.

FIG. 9 illustrates computing device 901 that is representative of any system or collection of systems in which the various processes, programs, services, and scenarios disclosed herein may be implemented. Examples of computing device 901 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof. Accordingly, computing device 901 may be representative of edge device 102. Further, servers executing instructions that support cloud-hosted services including service 116 and model datastore may be represented by computing device 901.

Computing device 901 may be implemented as a single apparatus, system, or device or may be implemented in a distributed manner as multiple apparatuses, systems, or devices. Computing device 901 includes, but is not limited to, processing system 902, storage system 903, software 905, communication interface system 907, and user interface system 909 (optional). Processing system 902 is operatively coupled with storage system 903, communication interface system 907, and user interface system 909.

Processing system 902 loads and executes software 905 from storage system 903. In some embodiments, processing system 902, storage system 903 and software 905 are part of SoC 104 described herein. In some embodiments, processing system 902 may include CPU 106, SPU 108, and security processor 110. Software 905 includes and implements model securing processes 906, which is (are) representative of the model securing, memory controller configuration, attestation processes, and so forth discussed with respect to the preceding figures, such as method 600. When executed by processing system 902, software 905 directs processing system 902 to operate as described herein for at least the various processes, operational scenarios, and sequences discussed in the foregoing implementations. Computing device 901 may optionally include additional devices, features, or functionality not discussed for purposes of brevity.

Referring still to FIG. 9, processing system 902 may comprise a microprocessor and other circuitry that retrieves and executes software 905 from storage system 903. Processing system 902 may be implemented within a single processing device but may also be distributed across multiple processing devices or sub-systems that cooperate in executing program instructions. Examples of processing system 902 include general purpose central processing units, graphical processing units, application specific processors, and logic devices, as well as any other type of processing device, combinations, or variations thereof.

Storage system 903 may comprise any computer readable storage media readable by processing system 902 and capable of storing software 905. Storage system 903 may include volatile and nonvolatile, removable and non-removable media implemented in any method or technology for storage of information, such as computer readable instructions, data structures, program modules, models, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 903 may also include computer readable communication media over which at least some of software 905 may be communicated internally or externally. Storage system 903 may be implemented as a single storage device but may also be implemented across multiple storage devices or sub-systems co-located or distributed relative to each other. Storage system 903 may comprise additional elements, such as a controller, capable of communicating with processing system 902 or possibly other systems.

Software 905 (including model securing processes 906) may be implemented in program instructions and among other functions may, when executed by processing system 902, direct processing system 902 to operate as described with respect to the various operational scenarios, sequences, and processes illustrated herein. For example, software 905 may include program instructions for implementing attestation, flexibly programming memory controller 112, executing model 212a, downloading model 212, and the like as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtualization software, or other application software. Software 905 may also comprise firmware (e.g., firmware 202, 204, 206) or some other form of machine-readable processing instructions executable by processing system 902.

In general, software 905 may, when loaded in to processing system 902 and executed, transform a suitable apparatus, system, or device (of which computing device 901 is representative) overall from a general-purpose computing system into a special-purpose computing system customized to support secure model execution in an optimized manner. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (e.g., between edge device 102 and service 116) over communication networks (not shown, e.g., the Internet, wide area networks, local area networks, wired networks, wireless networks, or the like). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A computer-implemented method for securing artificial intelligence (AI) models executed at an edge computing device, the method comprising:
downloading, by the edge computing device, an encrypted AI model;
attesting to, by a security processor of the edge computing device, an identity of firmware of a plurality of hardware modules of the edge computing device;
receiving, by the security processor in response to the attesting, a decryption key;
decrypting, by the security processor, the encrypted AI model using the decryption key;
writing, by the security processor, the decrypted AI model to a protected memory space, wherein data written to the protected memory space by the plurality of hardware modules is encrypted by a memory controller using an encryption key not available to other hardware modules not in the plurality of hardware modules; and
retrieving and executing, by at least one of the plurality of hardware modules, at least a portion of the AI model from the protected memory space.

2. The computer-implemented method of claim 1, wherein:
the plurality of hardware modules comprises:
the security processor, and
at least one of a neural processing unit and a graphics processing unit; and
the other hardware modules comprise a central processing unit.

3. The computer-implemented method of claim 2, further comprising:
reading, by the central processing unit, data from the protected memory space, wherein:
the central processing unit accesses the protected memory space via the memory controller,
the memory controller decrypts the data using a second encryption key available to the central processing unit, and
the data decrypted using the second encryption key is unintelligible by the central processing unit.

4. The computer-implemented method of claim 2, wherein the at least one of the plurality of hardware modules retrieving and executing the AI model comprises the neural processing unit, the graphics processing unit, or a combination thereof.

5. The computer-implemented method of claim 1, wherein the attesting to the identity of the firmware comprises:
for each of the plurality of hardware modules:
loading the respective firmware onto a first hardware module of the plurality of hardware modules;
measuring the respective firmware by the first hardware module; and
providing the measurement of the respective firmware for the attesting.

6. The computer-implemented method of claim 1, wherein the plurality of hardware modules, a memory comprising the protected memory space, the memory controller, and at least one of the other hardware modules are all incorporated into a system on a chip (SoC).

7. The computer-implemented method of claim 1, further comprising:
programming, by the security processor, the memory controller, wherein the programming comprises instructing the memory controller to:
encrypt the data written to the protected memory space by any of the plurality of hardware modules with the encryption key;
use the encryption key to decrypt the data when read from the protected memory space by any of the plurality of hardware modules; and
use a different encryption key corresponding to a requesting hardware module to encrypt and decrypt the data when written to and read from the protected memory space by any other hardware module not in the plurality of hardware modules.

8. The computer-implemented method of claim 1, wherein the attesting to the identity of the firmware comprises a freshness element indicating the identity of the firmware corresponding to each of the plurality of hardware modules is current.

9. The computer-implemented method of claim 1, wherein the encrypted AI model is downloaded to a second memory space, wherein the memory controller does not encrypt data written to the second memory space.

10. The computer-implemented method of claim 1, wherein the executing the AI model comprises:
accessing, by the at least one of the plurality of hardware modules, a second memory space to read input data;
processing, by the at least one of the plurality of hardware modules, the input data with the AI model; and
writing, by the at least one of the plurality of hardware modules, output data from the AI model to a third memory space, wherein:
the memory controller encrypts data written to at least one of the second memory space with a second encryption key and the third memory space with a third encryption key when written by one of the plurality of hardware modules, and
the second encryption key and the third encryption key are not available to the other hardware modules.

11. The computer-implemented method of claim 1, further comprising:
enforcing, by the one or more security processors, license limitations on the AI model, wherein the license limitations comprise at least one of a number of times the AI model may be executed, a number of concurrent executions of the AI model, and a duration of time during which the AI model may be executed.

12. A system on a chip (SoC), comprising:
a central processing unit;
a memory controller configured to:
control access to a memory,
configure a protected memory space of the memory, and
encrypt data written to the protected memory space with an encryption key corresponding to a requestor;
one or more security processors configured to:
attest to an identity of firmware of a plurality of hardware modules comprising a specialized processing unit and the one or more security processors;
receive, in response to the attesting, a decryption key;
decrypt an encrypted AI model stored in the memory using the decryption key; and
write the decrypted AI model to the protected memory space of the memory, wherein the memory controller encrypts the AI model using the encryption key corresponding to the one or more security processors, and wherein the encryption key is not available to other hardware modules not in the plurality of hardware modules, and wherein the central processing unit is one of the other hardware modules; and
the specialized processing unit configured to:
access the protected memory space via the memory controller; and
retrieve and execute at least a portion of the AI model from the protected memory space.

13. The SoC of claim 12, wherein the specialized processing unit is one of a neural processing unit, a graphics processing unit, or a combination thereof.

14. The SoC of claim 12, wherein to attest to the identity of the firmware, the one or more security processors are further configured to:
for each of the plurality of hardware modules:
load the respective firmware onto a first hardware module of the plurality of hardware modules;
measure the respective firmware by the first hardware module; and
provide the measurement of the respective firmware for the attestation.

15. The SoC of claim 14, wherein to attest to the identity of the firmware, the one or more security processors are further configured to:
incorporate a freshness element indicating the identity of the firmware corresponding to each of the plurality of hardware modules is current.

16. The SoC of claim 12, wherein the one or more security processors are further configured to:
program the memory controller to configure the protected memory space, wherein the programming comprises instructing the memory controller to:
encrypt the data written to the protected memory space by any of the plurality of hardware modules with the encryption key;
use the encryption key to decrypt the data when read from the protected memory space by any of the plurality of hardware modules; and
use a different encryption key corresponding to a requesting hardware module to encrypt and decrypt the data when written to and read from the protected memory space by any other hardware module not in the plurality of hardware modules.

17. The SoC of claim 12, wherein:
the central processing unit is configured to:
download the encrypted AI model, and
write the encrypted AI model in a second memory space of the memory; and
the memory controller is further configured to:
configure the second memory space of the memory, wherein data written to the second memory space is not encrypted by the memory controller.

18. The SoC of claim 12, wherein:
the central processing unit is configured to:
read the AI model from the protected memory space via the memory controller, wherein the memory controller decrypts the AI model with a second encryption key corresponding to the central processing unit, and wherein the AI model decrypted with the second encryption key is unintelligible by the central processing unit.

19. The SoC of claim 12, wherein the one or more security processors are further configured to:
enforce license limitations on the AI model, wherein the license limitations comprise at least one of a number of times the AI model may be executed, a number of concurrent executions of the AI model, and a duration of time during which the AI model may be executed.

20. The SoC of claim 12, wherein:
the memory controller is further configured to:
configure a second protected memory space of the memory, and
encrypt data written to the second protected memory space with a second encryption key corresponding to a requestor; and
the specialized processing unit is further configured to:
access a third memory space to read input data;
execute the at least the portion of the AI model to process the input data; and
write output data from the AI model to the second protected memory space, wherein:
the memory controller encrypts the output data written to the second protected memory space with the second encryption key corresponding to the specialized processing unit, and
the second encryption key is not available to the other hardware modules.
